(19) United States
(12) Patent Application Publication
(10) Pub. No.: US 2015/0179991 A1
(43) Pub. Date: Jun. 25, 2015

(54) POWER STORAGE MODULE AND POWER STORAGE DEVICE

(71) Applicants: Junta Katayama, Miyoshi-shi (JP); Hirotaka Watanabe, Toyota-shi (JP); Takuro Nakayama, Okazaki-shi (JP)

(72) Inventors: Junta Katayama, Miyoshi-shi (JP); Hirotaka Watanabe, Toyota-shi (JP); Takuro Nakayama, Okazaki-shi (JP)

(73) Assignee: TOYOTA JIDOSHA KABUSHIKI KAISHA, Toyota-shi, Aichi-ken (JP)

(21) Appl. No.: 14/415,034

(22) PCT Filed: Oct. 3, 2013
(86) PCT No.: PCT/IB2013/002184

§ 371 Date: Jan. 15, 2015

(30) Foreign Application Priority Data
Oct. 18, 2012 (JP) 2012-230889

(51) Int. Cl. H01M 2/02; H01M 2/30; H01M 2/12

(52) U.S. Cl. CPC H01M 2/024; H01M 2/1223; H01M 2/30; H01M 2220/20

(57) ABSTRACT

A battery module has a first power generating element (20) and a second power generating element (20) that are electrically connected in series to perform charging and discharging, a case (10) that houses the first power generating element and the second power generating element in a sealed state, a positive electrode terminal (52) that is electrically connected to a positive electrode of the first power generating element, a negative electrode terminal (53) that is electrically connected to a negative terminal of the second power generating element, and a valve (12d) that releases a gas generated in the case to the outside. The positive electrode terminal, the negative electrode terminal, and the case are provided in an installation area of the case that faces a specified direction, and the positive electrode terminal and the negative electrode terminal are disposed in one end side of the installation area while the valve is disposed in the other end side of the installation area.

### BACKGROUND OF THE INVENTION

1. Field of the Invention

The present invention relates to a power storage module in which a power generating element is housed in a case and the case is provided with an electrode terminal and a valve, and also to a power storage device.

2. Description of Related Art

In Japanese Patent Application Publication No. 2009-205820 (JP 2009-205820 A), a battery cell is provided with a positive electrode terminal and a negative electrode terminal, and a valve is provided between the positive electrode terminal and the negative electrode terminal. The valve is used to discharge a gas generated in the battery cell to the outside of the battery cell.

### SUMMARY OF THE INVENTION

In a secondary battery that is provided with a valve, a gas is discharged from the valve. Accordingly, when the valve and electrode terminals (such as a positive electrode terminal and a negative electrode terminal) are disposed on a same exterior surface of the secondary battery, it is preferred that the valve and the electrode terminals be disposed as far as possible from each other.

A first aspect of the present invention relates to a power storage module. The power storage module includes a first power generating element, a second power generating element, a case, a positive electrode terminal, a negative electrode terminal, and a valve. The first power generating element configured to perform charging and discharging. The second power generating element is electrically connected to the first power generating element in series. The second power generating element is configured to perform charging and discharging. The case houses the first power generating element and the second power generating element in a sealed state. The positive electrode terminal is electrically connected to a positive electrode of the first power generating element. The negative electrode terminal is electrically connected to a negative electrode of the second power generating element. The valve is configured to release a gas that is generated in the case to the outside of the case. The positive and negative electrode terminals and the valve are provided in an installation area of the case. The installation area faces a specified direction. The positive and negative electrode terminals are disposed in one end side of the installation area. The valve is disposed in another end side of the installation area.

Because the first power generating element and the second power generating element are electrically connected in series, the positive electrode of the first power generating element and the negative electrode of the second power generating element can be positioned in one end side of the case. Along with the above, the positive electrode terminal and the negative electrode terminal can be disposed together in the one end side of the installation area.

When the positive electrode terminal, the negative electrode terminal, and the valve are provided in the installation area (in other words, in a same area), an area in which the positive electrode terminal and the negative electrode terminal are disposed and an area in which the valve is disposed are divided into both ends of the installation area. Accordingly, the positive electrode terminal and the negative electrode terminal can easily be separated from the valve.

If the positive electrode terminal and the negative electrode terminal are positioned away from the valve, a movement passage of the gas that is discharged from the valve can easily be secured. For example, when the movement passage of the gas is formed by using a duct, the duct is less likely to interfere with the positive electrode terminal and the negative electrode terminal, and thus it is easy to dispose the duct. Meanwhile, the positive electrode terminal and the negative electrode terminal are disposed together in the one end side of the installation area. Accordingly, when wires are connected to the positive electrode terminal and the negative electrode terminal, for example, the wires can be connected simultaneously, and thus workability can be improved.

An intermediate terminal may be provided in the power storage module. The intermediate terminal may electrically be connected to a negative electrode of the first power generating element and a positive electrode of the second power generating element. The intermediate terminal may be disposed in a position in the installation area that is adjacent to the positive electrode terminal and the negative electrode terminal. Accordingly, the intermediate terminal can be disposed away from the valve. The power storage module may include a connecting tab. The connecting tab may be connected to the intermediate terminal, the first power generating element, and the second power generating element. The connecting tab may be housed in the case.

In the power storage module, the connecting tab may be disposed between the installation area and the first and second power generating elements, and the connecting tab may be disposed between the first power generating element and the second power generating element when seen from the specified direction. The gas that is generated in the case is generated from the first power generating element or the second power generating element. As described above, even when the gas is generated from the first power generating element, or when the gas is generated from the second power generating element, it is possible by disposing the connecting tab to prevent the gas that advances to the valve from being blocked by the connecting tab. In other words, the gas can easily be guided to the valve in the case.

The power storage module may include a partitioning member. The partitioning member may be provided in the case. The partitioning member may partition between the first power generating element and the second power generating element. The first power generating element and the second power generating element can easily be housed in the case by using the partitioning member. In addition, the first power generating element and the second power generating element can be prevented from contacting each other by using the partitioning member.

In the power storage module, the case may include a case main body and a lid. The case main body may house the first power generating element and the second power generating element. The case main body may include an opening through which the first power generating element and the second power generating element are assembled. The lid may close the opening of the case main body and constitute the installation area. The case can be in the sealed state by bringing the lid into close contact with the opening of the case main body.

In the power storage module, the installation area may be a rectangular area. The positive electrode terminal and the negative electrode terminal may be disposed in one end side of the rectangular area in a longitudinal direction. The valve may be disposed in another end side of the rectangular area in the longitudinal direction. In this case, the valve and a combination of the positive electrode terminal and the negative electrode terminal can respectively be disposed at different ends of the rectangular area (the installation area) in the longitudinal direction. Accordingly, the positive electrode terminal and the negative electrode terminal can be disposed farthest from the valve.

A second aspect of the present invention relates to a power storage device. The power storage device includes the plural power storage modules. The plural power storage modules are electrically connected to each other. More specifically, the power storage device can be configured by electrically connecting the plural power storage modules in series or in parallel. In addition, the plural power storage modules can be aligned in a specified direction. The plural power storage modules can be disposed such that the valve of each of the power storage modules is aligned in the specified direction. Accordingly, the duct that extends in the specified direction can be disposed adjacent to the valve of each of battery modules, and the gas can be discharged by using the duct.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an external view of a battery module;

FIG. 2 is an exploded view of the battery module;

FIG. 3 is a development view of a power generating element;

FIG. 4 is an external view of the power generating element;

FIG. 5 is a top view for showing peripheral structures of a positive electrode terminal and a negative electrode terminal;

FIG. 6 is a view for showing a circuit configuration of the battery module;

FIG. 7 is a schematic view of the battery module;

FIG. 8 is an external view of a battery pack;

FIG. 9 is a view of the battery pack seen from an arrangement direction of the plural battery modules;

FIG. 10 is a modification of a structure to adjust a temperature of the battery module;

FIG. 11 is a modification of the structure to adjust the temperature of the battery module; and

FIG. 12 is a modification of the structure to adjust the temperature of the battery module.

### DETAILED DESCRIPTION OF EMBODIMENTS

A description will hereinafter be made on an embodiment of the present invention.

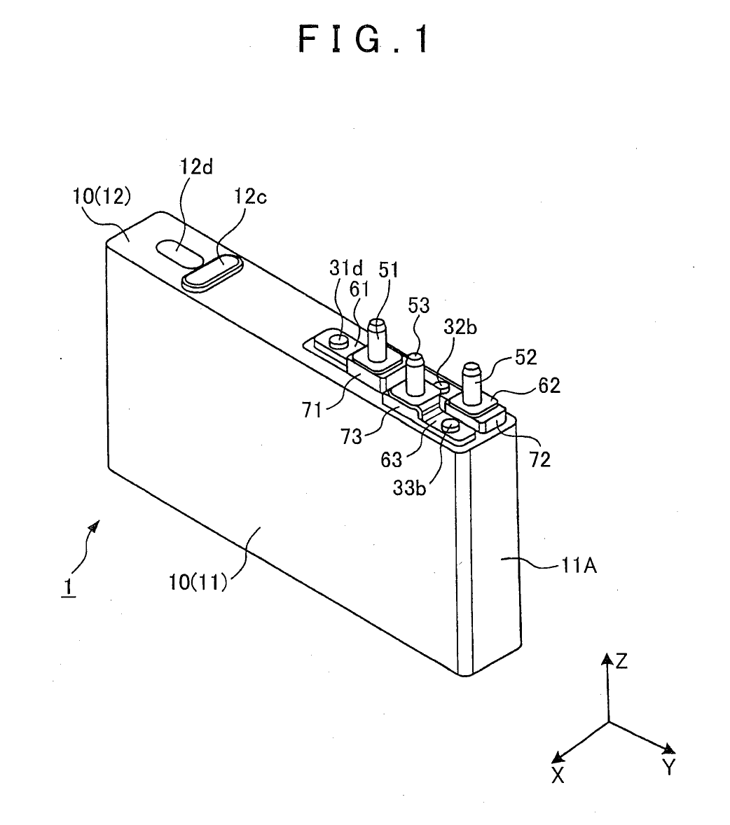

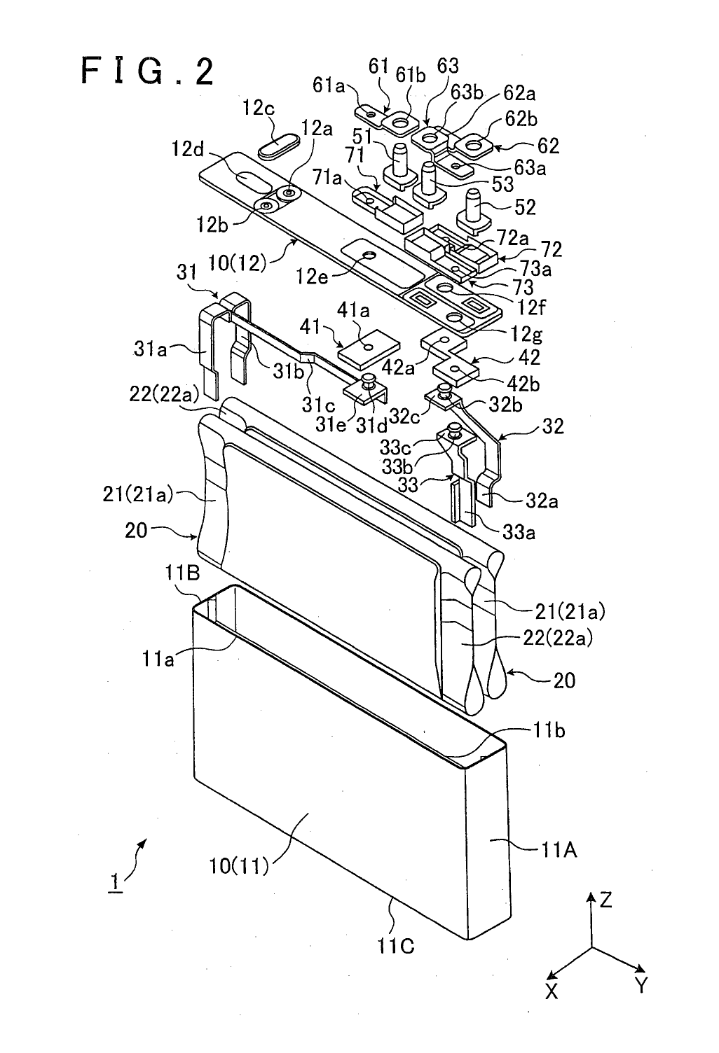

A description is now made on a battery module (corresponding to a power storage module of the present invention) as a first embodiment. FIG. 1 is an external view of the battery module, and FIG. 2 is an exploded view of the battery module. In FIG. 1 and FIG. 2, an X-axis, a Y-axis, and a Z-axis are orthogonal to each other, and, in this embodiment, the Z-axis corresponds to a vertical direction in the drawings. A relationship among the X-axis, the Y-axis, and the Z-axis is the same in the other drawings.

A battery module 1 has a module case 10, and two power generating elements 20 are housed in the module case 10. The module case 10 is formed in a rectangular parallelepiped shape and has a case main body 11 and a lid 12. The case main body 11 and the lid 12 can be formed of a metal such as aluminum.

The case main body 11 has an opening 11a to assemble the power generating elements 20 therethrough, and the opening 11a is closed by the lid 12. The lid 12 is attached to the case main body 11, thereby sealing the module case 10. For example, the module case 10 can be brought into a sealed state by welding the case main body 11 and the lid 12.

A partitioning section (may be regarded as a partition member of the present invention) 11b is provided in the case main body 11. The partitioning section 11b is used to partition a space formed in the case main body 11 into two spaces. The partitioning section 11b is integrally formed with three surfaces 11A to 11C of the case main body 11. The surfaces 11A, 11B face each other in a Y-direction, and are also side surfaces of the case main body 11 that form X-Z planes. The surface 11C is a bottom surface of the case main body 11 that forms an X-Y plane.

When the lid 12 is fixed to the case main body 11 (the opening 11a), an upper end of the partitioning section 11b is partially separated from the lid 12 and thus does not partially contact the lid 12. Although the partitioning section 11b is integrally formed with the case main body 11 in this embodiment, the partitioning section 11b can be configured as a member different from the case main body 11.

The two spaces that are formed by the partitioning section 11b each house the power generating element 20. In other words, the partitioning section 11b is located between the two power generating elements 20. The case main body 11 is provided with the partitioning section 11b to form the space for housing each of the power generating elements 20 in the case main body 11. Thus, the two power generating elements 20 can easily be housed in the case main body 11.

An insulating layer can be formed between the module case 10 (including the partitioning section 11b) and each of the power generating elements 20 when the power generating elements 20 are housed in the module case 10. For example, a film formed of an insulating material such as a resin can be disposed between the module case 10 and each of the power generating elements 20. Accordingly, the two power generating elements 20 can be housed in the module case 10 while the two power generating elements 20 are maintained in an insulated state.

If the partitioning section 11b is formed of an insulating material, it is possible to insulate between the two power generating elements 20. In addition, although the case main body 11 is provided with the partitioning section 11b in this embodiment, the partitioning section 11b can be removed. In this case, it is preferred that each of the two power generating elements 20 be covered with the insulating layer to bring the power generating elements 20 into the insulated state.

The power generating element 20 is an element to perform charging and discharging. As the power generating element 20, a power generating element that is used for a secondary battery, such as a nickel-hydrogen battery and lithium ion battery, can be used. In addition, as the power generating element 20, a power generating element that is used for an electric double-layer capacitor can be used.

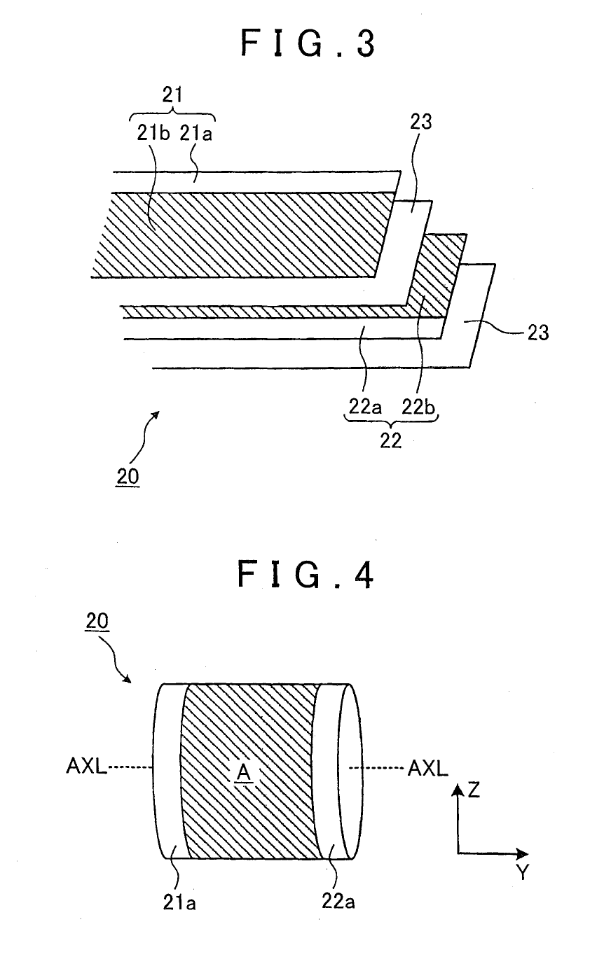

FIG. 3 is a development view of the power generating element 20. As shown in FIG. 3, the power generating element 20 has a positive electrode plate 21, a negative electrode plate 22, and separators 23. It should be noted that the two power generating elements 20 housed in the module case 10 have the same structure.

The positive electrode plate 21 has a current collector plate 21a and a positive electrode active material layer 21b that is formed on a surface of the current collector plate 21a. The positive electrode active material layer 21b contains a positive electrode active material and can appropriately incorporate a conductive agent, a binder, or the like into the positive electrode active material layer 21b. The positive electrode active material layer 21b is formed in a part of an area of the current collector plate 21a, and the rest of the area of the current collector plate 21a is exposed.

The negative electrode plate 22 has a current collector plate 22a and a negative electrode active material layer 22b that is formed on a surface of the current collector plate 22a. The negative electrode active material layer 22b contains a negative electrode active material and can appropriately incorporate a conductive agent, a binder, or the like into the negative electrode active material layer 22b. The negative electrode active material layer 22b is formed in a part of an area of the current collector plate 22a, and the rest of the area of the current collector plate 22a is exposed. The positive electrode active material layer 21b, the negative electrode active material layer 22b, and the separators 23 are soaked with an electrolytic solution.

The positive electrode plate 21, the negative electrode plate 22, and the separators 23 are laminated in an order shown in FIG. 3, and this laminated body is wound about an axis AXL shown in FIG. 4 to configure the power generating element 20. In FIG. 4, only the current collector plate 21a of the positive electrode plate 21 is wound at an end of the power generating element 20 in the Y-direction. Meanwhile, only the current collector plate 22a of the negative electrode plate 22 is wound at the other end of the power generating element 20 in the Y-direction.

In an area A that is shown in FIG. 4, the positive electrode active material layer 21b and the negative electrode active material layer 22b face each other while holding the separator 23 therebetween, and charging and discharging is performed. An outer surface of the power generating element 20 in the area A is covered with the separator 23.

In this embodiment, the power generating element 20 has a configuration illustrated in FIG. 4. However, the configuration of the power generating element 20 is not limited thereto. For example, the power generating element 20 can be configured by simply laminating the positive electrode plate 21, the negative electrode plate 22, and the separators 23. In this case, a solid electrolyte layer can be used instead of the separator 23. A known material can appropriately be selected as a material for the solid electrolyte layer.

The two power generating elements 20 that are housed in the module case 10 are electrically connected in series by a connecting tab 31. The connecting tab 31 has the first arm 31a, the second arm 31b, and the third arm 31c. A tip of the first arm 31a is connected to the positive electrode plate 21 (the current collector plate 21a) in one of the power generating elements 20. The first arm 331a and the positive electrode plate 21 can be fixed to each other by welding, for example. The rest of the first arm 31a except the tip thereof is formed in a shape to avoid interference with the power generating element 20 and is disposed between the one of the power generating elements 20 and the case main body 11.

A tip of the second arm 31b is fixed to the negative electrode plate 22 (the current collector plate 22a) in the other of the power generating elements 20. The second arm 31b and the negative electrode plate 22 can be fixed to each other by welding, for example. The rest of the second arm 31b except the tip thereof is formed in a shape to avoid interference with the power generating element 20 and is disposed between the other of the power generating element 20 and the case main body 11. The first arm 31a and the second arm 31b are respectively disposed in one end side of the one and one end side of the other of the power generating elements 20 in the Y-direction.

In this embodiment, the two power generating elements 20 are electrically connected in series by using the first arm 31a and the second arm 31b. However, the present invention is not limited thereto. In other words, any configuration can be adopted as long as the two power generating elements 20 can electrically be connected in series. More specifically, one arm is disposed between the two power generating elements 20, and this arm can be connected to the positive electrode plate 21 of one of the power generating elements 20 and to the negative electrode plate 22 of the other of the power generating elements 20.

The third arm 31c extends in the Y-direction along an inner wall surface of the lid 12, and is disposed above the power generating elements 20 and in a position between the two power generating elements 20. In other words, the third arm 31c is positioned above the partitioning section 11b.

A pin 31d is provided at a tip of the third arm 31c. The pin 31d penetrates the lid 12, and a tip of the pin 31d is projected to the outside of the module case 10. The pin 31d is supported by a base 31e, and a sheet (insulating sheet) 41 that is formed of an insulating material is disposed between the base 31e and the lid 12.

The base 31e and the lid 12 are each formed of a material having conductivity. However, it is possible to bring the base 31e and the lid 12 into the insulated state by arranging the insulating sheet 41 between the base 31e and the lid 12. The insulating sheet 41 has an opening 41a that allows the pin 31d to penetrate.

A positive electrode tab 32 that is formed of a conductive material is connected to the positive electrode plate 21 (the current collector plate 21a) in one of the power generating elements 20, the positive electrode tab 32 is housed in the module case 10. An end of the positive electrode tab 32 is provided with a connecting section 32a that is connected to the positive electrode plate 21 of the power generating elements 20. The connecting section 32a and the positive electrode plate 21 can be connected to each other by welding, for example. The rest of the positive electrode tab 32 except the connecting section 32a is formed in a shape to avoid interference with the power generating element 20 and is disposed between the other of the power generating elements 20 and the case main body 11.

The other end of the positive electrode tab 32 is provided with a pin 32b, and the pin 32b is supported by a base 32c. A sheet (an insulating sheet) 42 that is formed of an insulating material is disposed between the base 32c and the lid 12. The positive electrode tab 32 (the base 32c) and the lid 12 are each formed of a material having conductivity. However, it is possible to bring the positive electrode tab 32 and the lid 12 into the insulated state by arranging the insulating sheet 42 between the base 32a and the lid 12. The insulating sheet 42 has an opening 42a that allows the pin 32b to penetrate.

A negative electrode tab 33 that is formed of a conductive material is connected to the negative electrode plate 22 (the current collector plate 22a) in the other of the power generating elements 20, and the negative electrode tab 33 is housed in the module case 10. An end of the negative electrode tab 33 is provided with a connecting section 33a that is connected to the negative electrode plate 22 of the power generating element 20. The connecting section 33a and the negative electrode plate 22 can be connected to each other by welding, for example. The rest of the negative electrode tab 33 except the connecting section 33a is formed in a shape to avoid interference with the power generating element 20 and is disposed between the one of the power generating elements 20 and the case main body 11.

The other end of the negative electrode tab 33 is provided with a pin 33b, the pin 33b is supported by a base 33c. The insulating sheet 42 is disposed between the base 33c and the lid 12, and the negative electrode tab 33 (the base 33c) and the lid 12 are held in the insulated state by the insulating sheet 42. The insulating sheet 42 has an opening 42b that allows the pin 33b to penetrate.

The lid 12 has two solution injection holes 12a, 12b, and the solution injection holes 12a, 12b are aligned in the X-direction. The solution injection holes 12a, 12b are used to inject an electrolyte solution into the module case 10. More specifically, the solution injection hole 12a is used to inject the electrolyte solution into one of the power generating elements 20 while the solution injection hole 12b is used to inject the electrolyte solution into the other of the power generating elements 20. The electrolyte solution can easily be injected into each of the power generating elements 20 by using the two solution injection holes 12a, 12b.

After the electrolyte solution is injected into the module case 10, the solution injection holes 12a, 12b are closed by a plug 12c. In this embodiment, the two solution injection holes 12a, 12b are provided. However, only one solution injection hole can be provided for a purpose of injecting the electrolyte solution into the module case 10.

The lid 12 has a valve 12d. The valve 12d is used to discharge a gas that is generated in the module case 10 to the outside of the module case 10. The valve 12d is provided in one end side of the lid 12 with respect to the solution injection holes 12a, 12b. When the battery module 1 (the power generating elements 20) is overcharged, a gas may be generated in the module case 10. The gas may be produced by thermal decomposition of the electrolyte solution, for example.

Because the module case 10 is sealed, internal pressure of the module case 10 is increased by generation of the gas in the module case 10. Once the internal pressure of the module case 10 reaches working pressure of the valve 12d, the valve 12d is shifted from a closed state to an open state. Once the valve 12d is shifted into the open state, the gas that exists in the module case 10 passes through the valve 12d and moves outside the module case 10.

In this embodiment, a valve of a so-called destructive type is used as the valve 12d. More specifically, the lid 12 is engraved to form the valve 12d of the destructive type. The valve 12d of the destructive type is irreversibly shifted from the closed state to the open state and thus cannot return to an original state. It should be noted that the valve 12d provided in the lid 12 is not limited to the destructive type and a valve of a so-called return type can be used. The valve of the return type is reversibly shifted between the closed state and the open state according to the internal pressure of the module case 10. The valve of the return type can be configured by a plug that blocks a passage of the gas and a spring that presses the plug against the passage of the gas.

The lid 12 has an opening 12e to allow the pin 31d to penetrate. An insulating layer is also provided between the pin 31d and the opening 12e, and the pin 31d and the lid 12 are brought into the insulated state. The pin 31d that penetrates the opening 12e is connected to a terminal lead 61. The terminal lead 61 has an opening 61a that allows the pin 31d to penetrate, and the pin 31d that penetrates the opening 61a is fixed to the terminal lead 61 by caulking. The terminal lead 61 is supported by a base 71, and the base 71 is formed with an opening 71a that allows the pin 31d to penetrate.

The base 71 is formed of an insulating material. Because the base 71 is disposed between the terminal lead 61 and the lid 12, the terminal lead 61 and the lid 12 can be in the insulated state by using the base 71 that is formed of the insulating material. The base 71 supports both of the terminal lead 61 and an intermediate terminal 51. Because the base 71 is disposed between the intermediate terminal 51 and the lid 12, the intermediate terminal 51 and the lid 12 can be in the insulated state. The intermediate terminal 51 is connected to the terminal lead 61, and the terminal lead 61 is formed with an opening 61b that allows the intermediate terminal 51 to penetrate.

The lid 12 has an opening 12f that allows the pin 32b to penetrate. The pin 32b that penetrates the opening 12f is connected to a terminal lead 62. The terminal lead 62 has an opening 62a that allows the pin 32b to penetrate, and the pin 32b that penetrates the opening 62a is fixed to the terminal lead 62 by caulking. The terminal lead 62 is supported by a base 72, and the base 72 is formed with an opening 72a that allows the pin 32b to penetrate.

The base 72 is formed of an insulating material. Because the base 72 is disposed between the terminal lead 62 and the lid 12, the terminal lead 62 and the lid 12 can be in the insulated state by using the base 72 that is formed of the insulating material. The base 72 supports both of the terminal lead 62 and a positive electrode terminal 52. Because the base 72 is disposed between the positive electrode terminal 52 and the lid 12, the positive electrode terminal 52 and the lid 12 can be in the insulated state. The positive electrode terminal 52 is connected to the terminal lead 62, and the terminal lead 62 is formed with an opening 62b that allows the positive electrode terminal 52 to penetrate.

The lid 12 has an opening 12g that allows the pin 33b to penetrate. The pin 33b that penetrates the opening 12g is connected to a terminal lead 63. The terminal lead 63 has an opening 63a that allows the pin 33b to penetrate, and the pin 33b that penetrates the opening 63a is fixed to the terminal lead 63 by caulking. The terminal lead 63 is supported by a base 73, and the base 73 is formed with an opening 73a that allows the pin 33b to penetrate.

The base 73 is formed of an insulating material. Because the base 73 is disposed between the terminal lead 63 and the lid 12, the terminal lead 63 and the lid 12 can be in the insulated state by using the base 73 that is formed of the insulating material. The base 71 supports both of the terminal lead 63 and a negative electrode terminal 53. Because the base 73 is disposed between the negative electrode terminal 53 and the lid 12, the negative electrode terminal 53 and the lid 12 can be in the insulated state. The negative electrode terminal 53 is connected to the terminal lead 63, and the terminal lead 63 is formed with an opening 63b that allows the negative electrode terminal 53 to penetrate.

A surface of the lid 12 to which the terminals 51 to 53 are attached faces an upper side of the battery module 1. In other words, the terminals 51 to 53 are provided on a surface of the module case 10 that faces a same direction.

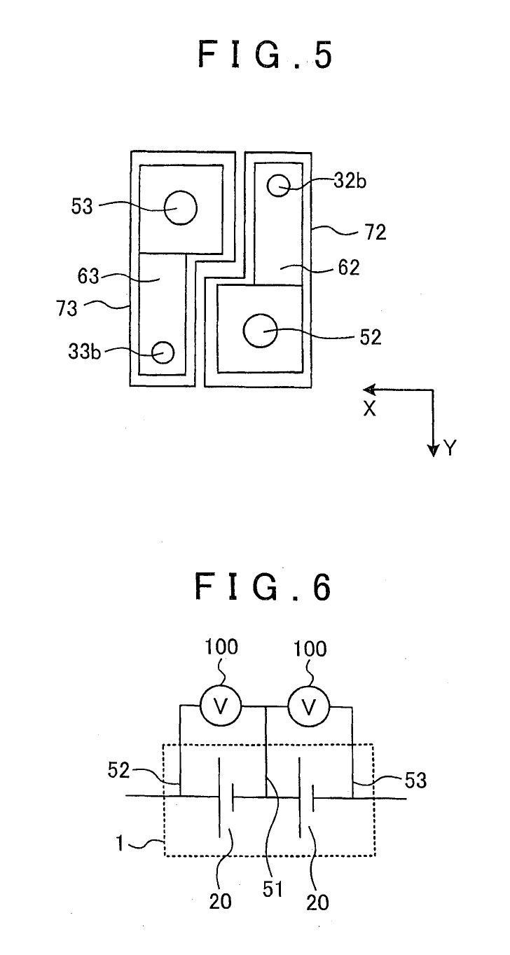

In this embodiment, as shown in FIG. 5, the positive electrode terminal 52 and the negative electrode terminal 53 are displaced from each other in the Y-direction. FIG. 5 is a view in which peripheral structures of the positive electrode terminal 52 and the negative electrode terminal 53 are seen from above the battery module 1. It is possible to prevent interference between the positive electrode terminal 52 and the negative electrode terminal 53 by displacing the positive electrode terminal 52 and the negative electrode terminal 53 from each other in the Y-direction.

In a case where the positive electrode terminal 52 and the negative electrode terminal 53 are aligned in the X-direction within a limited space of the lid 12, the positive electrode terminal 52 and the negative electrode terminal 53 may interfere with each other. If the battery module 1 is enlarged in the X-direction, the positive electrode terminal 52 and the negative electrode terminal 53 can be aligned in the X-direction without causing the interference therebetween. However, this causes an increase in size of the battery module 1. In this embodiment, the positive electrode terminal 52 and the negative electrode terminal 53 can be disposed on the battery module 1 (the lid 12) while the battery module 1 is downsized in the X-direction.

In this embodiment, the positive electrode terminal 52 and the negative electrode terminal 53 are disposed together in one end side of the lid 12 in the Y-direction. Also, the intermediate terminal 51 is disposed in a position adjacent to the positive electrode terminal 52 and the negative electrode terminal 53. Accordingly, the terminals 51 to 53 are disposed together in the one end side of the lid 12 in the Y-direction. A connecting part such as a wire is connected to each of the terminals 51 to 53. However, because the terminals 51 to 53 are disposed together in the one end side of the lid 12, the connecting parts for the terminals 51 to 53 can be connected simultaneously, and the connecting parts can be disposed together in the one end side of the lid 12.

The intermediate terminal 51 is used to detect a voltage of each of the power generating elements 20. FIG. 6 shows a circuit configuration of the battery module 1. If a voltage sensor 100 is connected to the intermediate terminal 51 and the positive electrode terminal 52, it is possible to detect the voltage of one of the power generating elements 20 included in the battery module 1. In addition, if the voltage sensor 100 is connected to the intermediate terminal 51 and the negative electrode terminal 53, it is possible to detect the voltage of the other of the power generating elements 20 included in the battery module 1.

Accordingly, even when the two power generating elements 20 are housed in the module case 10, it is possible to monitor the voltage of each of the power generating elements 20. If a voltage sensor is connected to the positive electrode terminal 52 and the negative electrode terminal 53, a voltage of the battery module 1 can be detected.

In this embodiment, the valve 12d is disposed in the one end side of the lid 12 in the Y-direction, and the terminals 51 to 53 are disposed in the other end side of the lid 12 in the Y-direction. Accordingly, it is possible to separate the terminals 51 to 53 from the valve 12d from which the gas is discharged. Also, in this embodiment, the lid 12 is formed in a rectangular shape, and a length of the lid 12 in the Y-direction is longer than a length of the lid 12 in the X-direction. Therefore, it is possible to easily separate the terminals 51 to 53 from the valve 12d by distributing the valve 12d and the terminals 51 to 53 to different ends of the lid 12 in the Y-direction.

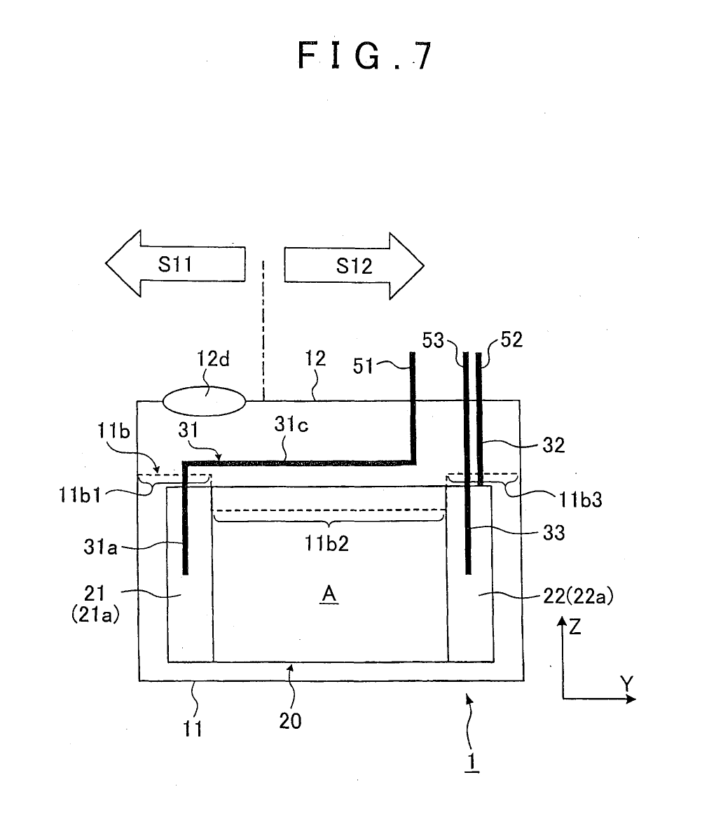

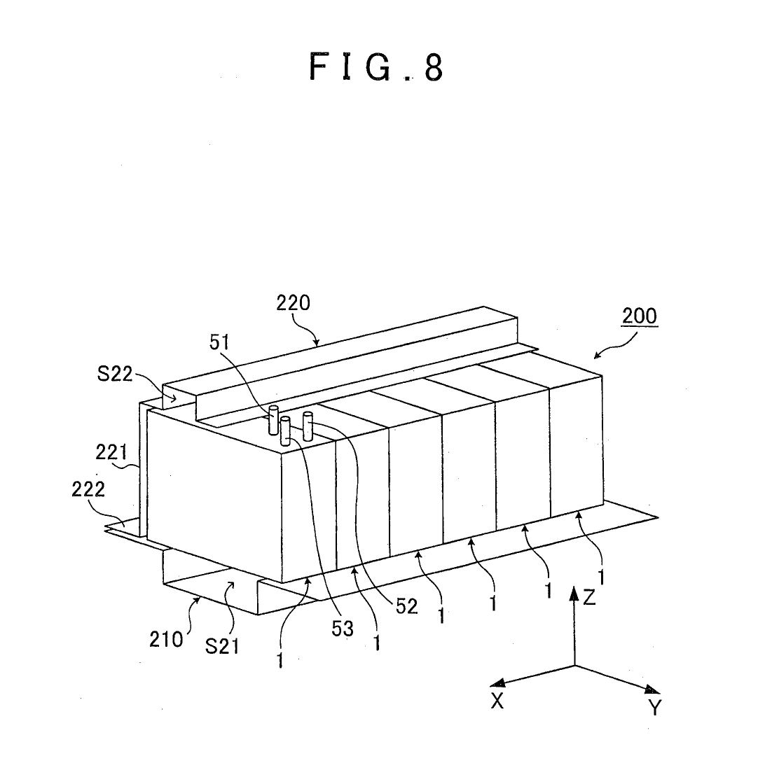

Furthermore, because the valve 12d and the terminals 51 to 53 are distributed to the different ends of the lid 12 in the Y-direction, a space positioned above the battery module 1 can be divided into two spaces S11, S12 as shown in FIG. 7. FIG. 7 is a schematic view of the battery module 1. The space S11 contains the valve 12d, and the space S11 can be used as the passage of the gas that is discharged from the valve 12d. Meanwhile, the space S12 contains the terminals 51 to 53 and can be used as a space to arrange the connecting parts that are connected to the terminals 51 to 53.

A dotted line in FIG. 7 indicates the upper end of the partitioning section 11b that is provided in the case main body 11. As shown in FIG. 7, end areas 11b1, 11b3 of the partitioning section 11b in the Y-direction are located above the power generating element 20. The end area 11b1 is located between the positive electrode plate 21 (the current collector plate 21a) in the one of the power generating elements 20 and the negative electrode plate 22 (the current collector plate 22a) in the other of the power generating elements 20, and prevents the positive electrode plate 21 and the negative electrode plate 22 from coming into contact with each other. The end area 11b3 is located between the negative electrode plate 22 (the current collector plate 22a) in the one of the power generating elements 20 and the positive electrode plate 21 (the current collector plate 21a) in the other of the power generating elements 20, and prevents the negative electrode plate 22 and the positive electrode plate 21 from coming into contact with each other.

A central area 11b2 of the partitioning section 11b is located below the end areas 11b1, 11b3. More specifically, an upper end of the central area 11b2 is located below an upper end of each of the power generating elements 20. The separator 23 is disposed on an outer surface of each of the power generating elements 20 in an area A. Accordingly, even when the two power generating elements 20 contact each other in the area A, the two power generating elements 20 can be maintained in the insulated state.

It is possible to prevent the third arm 31c of the connecting tab 31 from interfering with the partitioning section 11b (the central area 11b2) by locating the upper end of the central area 11b2 below upper ends of the end areas 11b 1, 11b3. In other words, the central area 11b2 of the partitioning section 11b is provided in a position to avoid interference with the connecting tab 31.

In this embodiment, the connecting tab 31 (the third arm 31c) is disposed above the partitioning section 11b. Accordingly, when the gas is generated in each of the power generating elements 20, it is possible to prevent movement of the gas toward the valve 12d from being blocked by the connecting tab 31. In other words, the gas that is generated in each of the power generating elements 20 can move to the valve 12d without causing collision with the connecting tab 31 (the third arm 31c). Therefore, the gas can be discharged smoothly by using the valve 12d.

Although the two power generating elements 20 are housed in the module case 10 in this embodiment, the number of the power generating element 20 is not limited thereto. More specifically, the even number of the power generating elements 20 can be housed in the module case 10. If the even number of the power generating elements 20 are housed in the module case 10, a positive electrode terminal and a negative electrode terminal of the battery module 1 can be disposed together in one location as in this embodiment.

Furthermore, the intermediate terminal 51 is provided in this embodiment. However, if the voltage of each of the power generating elements 20 does not have to be detected, the intermediate terminal 51 can be removed. Along with removal of the intermediate terminal 51, the connecting tab 31 can also be removed.

A battery pack 200 that is shown in FIG. 8 can be configured by using the battery module 1 of this embodiment. More specifically, the battery pack 200 can be configured by aligning the plural battery modules 1 in the X-direction. The number of the battery module 1 that constitutes the battery pack 200 can appropriately be set.

FIG. 8 shows the terminals 51 to 53 for only one of the battery modules 1, and the terminals 51 to 53 are not shown for the rest of the battery modules 1. The plural battery modules 1 are disposed such that the terminals 51 to 53 of the respective battery modules 1 are aligned in the X-direction.

When the plural battery modules 1 are aligned in the X-direction, a restraining force can be applied to the plural battery modules 1. The restraining force is a force to hold each of the battery modules 1 between sides thereof in the X-direction. For example, a pair of end plates can be disposed at both ends of the battery pack 200 in the X-direction, and both ends of a coupling member that extends in the X-direction can be fixed to the pair of end plates.

Accordingly, the pair of end plates can be displaced in a direction to approach each other (the X-direction) and thus can apply the restraining force to the plural battery modules 1 that are held between the pair of end plates. The coupling member only needs to extend in the X-direction, and a cross-sectional shape thereof that is obtained by cutting the coupling member in a plane orthogonal to a longitudinal direction (the X-direction) can appropriately be set. For example, the cross-sectional shape of the coupling member can be a circular shape or a rectangular shape.

In this embodiment, the two power generating elements 20 are housed in the module case 10. Accordingly, when the gas is generated in one of the power generating elements 20, heat generated in the one of the power generating elements 20 can be released to the other of the power generating elements 20. Therefore, it is possible to suppress a temperature increase of the battery module 1 in which the gas is generated, and it is also possible to restrict the heat of this battery module 1 from transferring to the other battery module 1.

The battery pack 200 that is shown in FIG. 8 can be installed in a vehicle, for example. More specifically, if electrical energy that is output from the battery pack 200 (the battery module 1) is converted to kinetic energy by a motor generator, it is possible to allow the vehicle to travel with the kinetic energy. In addition, if the kinetic energy that is generated during braking of the vehicle is converted to the electrical energy by the motor generator, the electrical energy can be stored in the battery pack 200 (the battery module 1).

The plural battery modules 1 that constitute the battery pack 200 can electrically be connected in series or parallel. For example, if the positive electrode terminal 52 of one of the two battery modules 1 is connected to the negative electrode terminal 53 of the other of the two battery modules 1 by a bus bar, the two battery modules 1 can electrically be connected in series.

A lower case 210 is disposed under the battery pack 200. The lower case 210 is partially away from a bottom surface of each of the battery modules 1, and a passage S21 is formed between the lower case 210 and the battery modules 1. The passage S21 extends in the X-direction and can be used as a passage through which a heat exchange medium for adjusting the temperature of the battery modules 1 moves.

Meanwhile, a duct 220 is disposed in the space S11 that is explained with FIG. 7. The duct 220 forms a passage S22 that extends in the X-direction. The passage S22 is located above the valve 12d of each of the battery modules 1, and the gas that is discharged from the valve 12d moves along the passage S22. The plural battery modules 1 are disposed such that the valves 12d of the battery modules 1 are aligned in the X-direction.

As described above, the valve 12d and the terminals 51 to 53 are disposed separately at different ends of the lid 12 in the Y-direction in this embodiment. Accordingly, when the passage S22 is formed by using the duct 220, it is possible to prevent interference of the duct 220 with the terminals 51 to 53. In addition, the passage S22 can easily be secured by separating the terminals 51 to 53 from the valve 12d.

The duct 220 has a vertical wall section 221 that extends along a side surface of each of the battery modules 1 (the surface 11B shown in FIG. 2) and a flange section 222 that is fixed to the lower case 210.

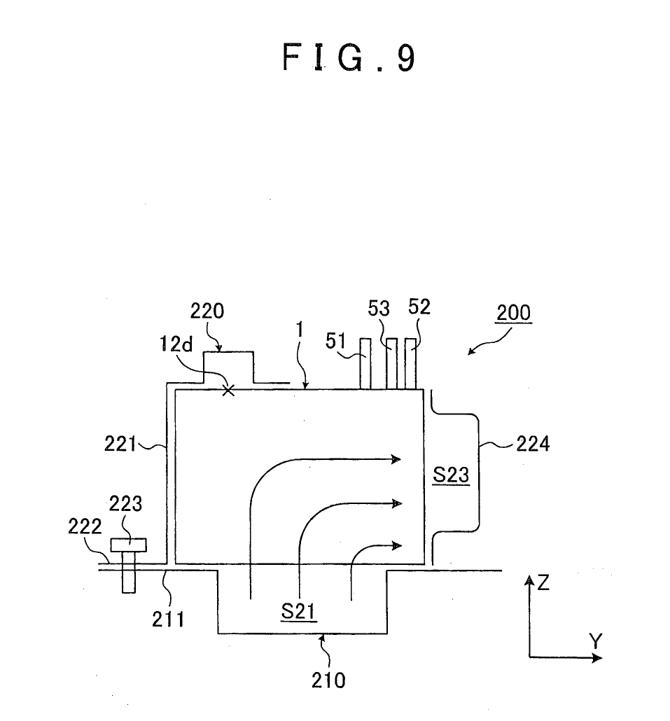

Next, a description is made on a structure of the battery pack 200 shown in FIG. 8 to adjust the temperature of each of the battery modules 1 with reference to FIG. 9. FIG. 9 is a view of the battery module 1 when the battery pack 200 is seen in the X-direction.

As shown in FIG. 9, the flange section 222 of the duct 220 is fixed to a flange section 211 of the lower case 210 by a bolt 223. A chamber 224 is disposed on a side surface of each of the battery modules 1 (the surface 11A shown in FIG. 2), and the chamber 224 forms a passage S23 through which a heat exchange medium moves. The passage S23 extends in the X-direction.

In the structure shown in FIG. 9, the passage S21 is used as a passage to supply the heat exchange medium to each of the battery modules 1. Meanwhile, the passage S23 is used as a passage to discharge the heat exchange medium. When the heat exchange medium is supplied to the passage S21, the heat exchange medium can be guided from the passage S21 to each of the battery modules 1 as shown in the arrows of FIG. 9. If a space is formed between the two battery modules 1 that are adjacent to each other in the X-direction, the heat exchange medium can be guided from the passage S21 to the space formed between the two battery modules 1.

When the battery module 1 is generating heat due to charging and discharging, the temperature increase of the battery module 1 can be suppressed by guiding the heat exchange medium for cooling to the battery module 1. On the other hand, when the battery module 1 is excessively cooled under the influence of an external environment, a temperature decrease of the battery module 1 can be suppressed by guiding the heat exchange medium for heating to the battery module 1. As described above, the temperature of the battery module 1 can be adjusted by performing heat exchange between the battery module 1 and the heat exchange medium. It should be noted that a gas such as air can be used as the heat exchange medium, for example.

In the battery module 1 of this embodiment, the two power generating elements 20 are housed in the module case 10. Therefore, when the heat exchange medium is guided to the battery module 1, it is preferred that the heat exchange medium be guided to the paired side surfaces (Y-Z planes) of the battery module 1 that are orthogonal to the X-axis. It is possible to efficiently adjust a temperature of the power generating element 20 that is adjacent to one of the side surfaces of the battery module 1 by bringing the heat exchange medium into contact with the one of the side surfaces (Y-Z planes) of the battery module 1. It is also possible to efficiently adjust the temperature of the power generating element 20 that is adjacent to the other of the side surfaces of the battery module 1 by bringing the heat exchange medium into contact with the other of the side surfaces (Y-Z planes) of the battery module 1.

The heat exchange medium that has performed the heat exchange with the battery module 1 can be guided to the passage S23. Accordingly, the heat exchange medium after the heat exchange can be discharged to the outside of the battery pack 200 by using the passage S23. In a structure shown in FIG. 9, the passage S21 is used as the passage to supply the heat exchange medium to the battery module 1 while the passage S23 is used as the passage to discharge the heat exchange medium from the battery module 1. However, the structure is not limited thereto.

More specifically, the passage S23 can be used as the passage to supply the heat exchange medium to the battery module 1 while the passage S21 can be used as the passage to discharge the heat exchange medium from the battery module 1. In this case, a direction in which the heat exchange medium moves is opposite from a direction indicated by the arrows in FIG. 9.

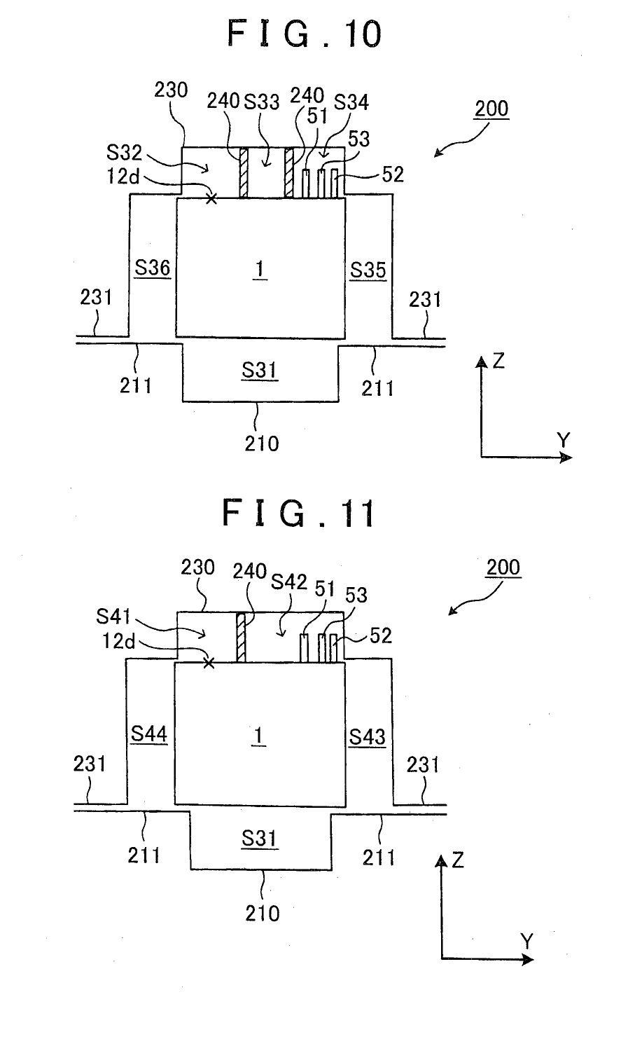

In this embodiment, the heat exchange medium is moved as shown in FIG. 9. However, movement of the heat exchange medium is not limited thereto. In other words, a passage to move the gas that is discharged from the valve 12d of the battery module 1 and a passage to move the heat exchange medium may be provided separately. In FIG. 10 to FIG. 12, another passage (another example) to move the heat exchange medium is shown.

In the battery pack 200 shown in FIG. 10, the plural battery modules 1 are surrounded by the lower case 210 and an upper case 230. The flange section 211 of the lower case 210 and a flange section 231 of the upper case 230 are fastened to each other by a bolt, for example. The lower case 210 forms a passage S31 through which the heat exchange medium moves below the battery module 1. The passage S31 extends in the X-direction.

Above the battery module 1, the upper case 230 forms a passage S32 through which the gas that is discharged from the valve 12d of the battery module 1 moves and a passage S33 through which the heat exchange medium moves. In a structure shown in FIG. 10, the passages S32, S33 and a space S34 in which the terminals 51 to 53 are located are provided above the battery module 1.

A pair of partitioning plates 240 is provided between the upper case 230 and the battery module 1, and each of the partitioning plates 240 extends in the X-direction. The passage S33 is formed by the paired partitioning plates 240 and the upper case 230. The partitioning plate 240 that is disposed between the passage S32 and the passage S33 contacts the upper case 230 and the battery module 1, and the passage S32 and the passage S33 are partitioned by the partitioning plates 240.

Accordingly, the partitioning plates 240 can prevent the gas that moves through the passage S32 from entering the passage S33. Meanwhile, the partitioning plate 240 that is disposed between the passage S33 and the space S34 contacts the upper case 230 and the battery module 1, and the passage S33 and the space S34 are partitioned by the partitioning plates 240. Accordingly, the partitioning plates 240 can prevent the heat exchange medium that moves through the passage S33 from being leaked into the space S34.

According to the structure shown in FIG. 10, one of the passages S31, S33 can be used as the passage to supply the heat exchange medium to the battery module 1 while the other thereof can be used as the passage to discharge the heat exchange medium from the battery module 1. Therefore, like the structure shown in FIG. 9, it is possible to bring the heat exchange medium into contact with each of the battery modules 1 and thus to adjust the temperature of each of the battery modules 1.

In the structure shown in FIG. 10, spaces S35, S36 are formed on both sides of the battery module 1 in the Y-direction by using the upper case 230. An apparatus that is disposed along with the battery module 1 can be housed in the spaces S35, 36. Examples of the apparatus include a monitoring unit for monitoring the voltage of the power generating element 20 or the battery module 1 and a temperature sensor for detecting the temperature of the battery module 1.

In a structure shown in FIG. 11, like the structure shown in FIG. 10, the plural battery modules 1 are surrounded by the lower case 210 and the upper case 230. In FIG. 11, components that, have the same functions as those explained with FIG. 10 are denoted by the same reference numerals.

In FIG. 11, the upper case 230 is away from the upper surface of the battery module 1, a passage S41 and a space S42 are formed between the upper case 230 and the battery module 1, and the passage S41 and the space S42 extend in the X-direction. The passage S41 serves as a passage through which the gas discharged from the valve 12d of the battery module 1 moves. The space S42 is a space in which the terminals 51 to 53 are located. In addition to the terminals 51 to 53, an apparatus that is disposed along with the battery module 1 can also be housed in the space S42.

A partitioning member 240 is disposed between the passage S41 and the space S42. The partitioning member 240 extends in the X-direction and contacts the upper case 230 and the battery module 1. Accordingly, the passage S41 and the space S42 are partitioned by the partitioning member 240, and it is possible to prevent the gas that moves through the passage S41 from entering the space S42.

In the upper case 230, a passage S43 and a space S44 are formed on both sides of the battery module 1 in the Y-direction. The passage S43 can be used as a passage through which the heat exchange medium moves. Although the space S44 can also be used as a passage through which the heat exchange medium moves, the space S44 is disposed next to the passage S41 through which the gas moves. Therefore, it is preferred that the passage S43 that is away from the passage S41 be used as the passage through which the heat exchange medium moves.

In the structure shown in FIG. 11, one of the passages S31, S43 may be used as a passage to supply the heat exchange medium to the battery module 1 while the other thereof may be used as a passage to discharge the heat exchange medium from the battery module 1. An apparatus that is disposed along with the battery module 1 can be housed in the space S44.

In the structure shown in FIG. 11, compared to the structure shown in FIG. 10, the passage through which the gas discharged from the valve 12d can be enlarged. In other words, the passage S41 shown in FIG. 11 can be made larger than the passage S32 shown in FIG. 10.

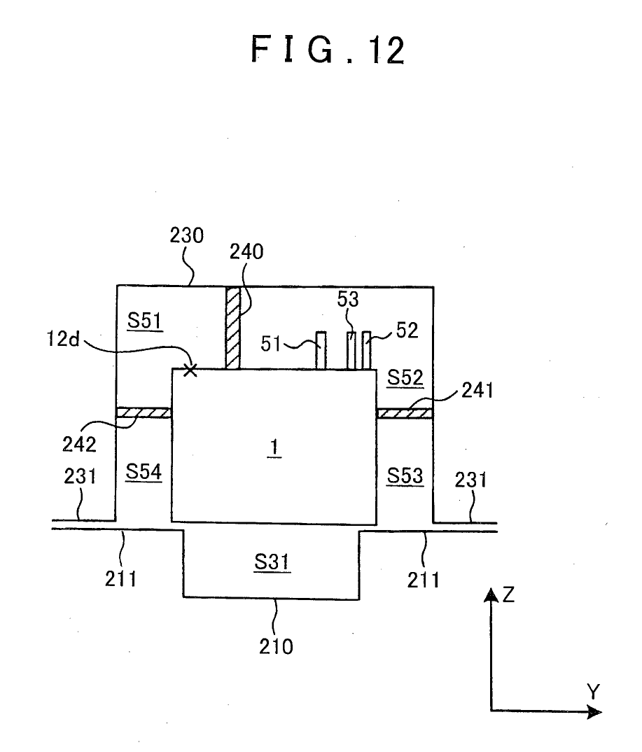

In a structure shown in FIG. 12, like the structure shown in FIG. 10, the plural battery modules 1 are surrounded by the lower case 210 and the upper case 230. The partitioning plate 240 is disposed between the upper case 230 and the upper surface of the battery module 1, and the partitioning plate 240 contacts the upper case 230 and the battery module 1.

A pair of partitioning plates 241, 242 is disposed in positions that hold each of the battery modules 1 therebetween in the Y-direction, and each of the partitioning plates 241, 242 extends in the X-direction. Each of the partitioning plates 241, 242 contacts each of the battery modules 1 and the upper case 230. A passage S53 is located under the partitioning plate 241, and the passage S53 is formed by the partitioning plate 241, the lower case 210, and the upper case 230. A passage S54 is located under the partitioning plate 242, and the passage S54 is formed by the partitioning plate 242, the lower case 210, and the upper case 230. As described below, the passages S53, S54 can be used as passages through which the heat exchange medium moves.

A space S52 is formed between the upper case 230 and the battery module 1 by the partitioning plate 240 and the partitioning plate 241. The terminals 51 to 53 are located in the space S52. In addition, an apparatus that is disposed along with the battery module 1 can also be housed in the space S52. The partitioning plate 241 contacts the upper case 230 and the battery module 1 and can prevent the heat exchange medium that moves through the passage S53 from being leaked into the space S52.

A passage S51 is formed between the upper case 230 and the battery module 1 by the partitioning plate 240 and the partitioning plate 242. The passage S51 extends in the X-direction and serves as a passage through which the gas discharged from the valve 12d of each of the battery modules 1 moves. The partitioning plates 240 contacts the upper case 230 and the battery module 1 and can prevent the gas that moves through the passage S51 from entering the space S52. The partitioning plate 242 contacts the upper case 230 and the battery module 1 and can prevent the gas that moves through the passage S51 from entering the passage S54.

In the structure shown in FIG. 12, the passage S31 may be used as a passage to supply the heat exchange medium to the battery module 1 while the passages S53, S54 may be used as passages to discharge the heat exchange medium from the battery module 1. On the contrary, the passage S53, S54 may be used as the passages to supply the heat exchange medium to the battery module 1 while the passage S31 may be used as the passage to discharge the heat exchange medium from the battery module 1.

1. A power storage module comprising:
a first power generating element configured to perform charging and discharging;
a second power generating element electrically connected to the first power generating element in series, and configured to perform charging and discharging;
a case housing the first power generating element and the second power generating element in a sealed state;
a positive electrode terminal electrically connected to a positive electrode of the first power generating element;
a negative electrode terminal electrically connected to a negative electrode of the second power generating element;
a valve configured to release a gas generated in the case to the outside of the case, the positive electrode terminal, the negative electrode terminal, and the valve being provided in an installation area of the case, the installation area facing a specified direction, the positive electrode terminal and the negative electrode terminals being disposed in one end side of the installation area, and the valve being disposed in the other end side of the installation area; and
an intermediate terminal electrically connected to a negative electrode of the first power generating element and a positive electrode of the second power generating element, the intermediate terminal being disposed in a position in the installation area that is adjacent to the positive electrode terminal and the negative electrode terminal.

2. (canceled)

3. The power storage module according to claim 1, further comprising:
a connecting tab connected to the intermediate terminal and to the first power generating element and the second power generating element, the connecting tab being housed in the case.

4. The power storage module according to claim 3, wherein
the connecting tab is disposed between the installation area and the first generating element and the second power generating element, and
the connecting tab is disposed between the first power generating element and the second power generating element when seen from the specified direction.

5. The power storage module according to claim 1, further comprising:
a partitioning member that is provided in the case, the partitioning member partitioning between the first power generating element and the second power generating element.

6. The power storage module according to claim 1, wherein
the case includes a case main body and a lid,
the case main body houses the first power generating element and the second power generating element,
the case main body includes an opening through which the first power generating element and the second power generating element are assembled, and
the lid covers the opening of the case main body and forms the installation area.

7. The power storage module according to claim 1, wherein
the installation area is a rectangular area,
the positive electrode terminal and the negative electrode terminal are disposed in one end side of the rectangular area in a longitudinal direction, and
the valve is disposed in another end side of the rectangular area in the longitudinal direction.

8. A power storage device comprising:
plural power storage modules according to claim 1, the plural power storage modules being electrically connected to each other.
